(19) United States
(12) Patent Application Publication
(10) Pub. No.: US 2007/0009213 A1
(43) Pub. Date: Jan. 11, 2007

(54) Optoelectronic assembly with heat sink

(76) Inventors: David John Kenneth Meadowcroft, Stowmarket (GB); Mark Jeffrey Dunn, Ipswich (GB)

Correspondence Address: AVAGO TECHNOLOGIES, LTD., P.O. BOX 1920, DENVER, CO, 80201-1920, US

(21) Appl. No.: 11/480,181

(22) Filed: Jun. 30, 2006

(30) Foreign Application Priority Data
Jul. 7, 2005 (GB) 0513958.9

(51) Int. Cl. G02B 6/36

(52) U.S. Cl. 385/92

(57) ABSTRACT

An optoelectronic assembly having a heat sink, and in particular to an optical receiver or transmitter unit for use in an optical fibre communication system in which a heat sink is provided to carry away heat generated by electrical components within the unit. The optoelectronic assembly comprises an optical transceiver unit, a heat sink and a housing. The optical transceiver unit has an interior containing at least one optoelectronic device with at least one electrical connection to said device for providing electrical power to the device, the electrical connection being made through an electrical contact on an external surface of the optical transceiver unit. The heat sink is mounted to the optical transceiver unit and is in thermal contact with both the optical transceiver unit and the housing to convey waste heat from within the optical transceiver unit to the housing. The heat sink has at least one conductive electrical path, the path extending between the electrical contact on the external surface of the transceiver unit to a connection terminal by which electrical power may be supplied to the optoelectronic device.

### BACKGROUND

a. Field of the Invention

The present invention relates to an optoelectronic assembly having a heat sink, and in particular to an optical receiver or transmitter unit for use in an optical fibre communication system in which a heat sink is provided to carry away heat generated by electrical components within the unit.

b. Related Art

All optoelectronic devices need to be operated within a defined temperature band. For example, a laser diode based fibre optic transmitter device may have a laser diode which is capable of operating over a range of temperatures between 0° C. to 80° C.

An optoelectronic device, for example a laser diode or a photodiode, mounted within an optoelectronic component such as an optical receiver or transmitter unit may need to be cooled, for example, owing to excess heat generated within the component or heating from other electrical equipment in proximity with the component. In some applications, the operating temperature of an optoelectronic device may not need to be carefully controlled, but must need to be kept below a maximum operating temperature. Whether or not a device has active thermoelectric cooling, it may be desirable to provide at least some passive temperature control with a heat sink. Cooling of an optoelectronic device is conventionally done by mounting the optoelectronic device on a thermoelectric cooler, which pumps heat away from the device, for example to heat fins on an external surface of the component. A conventional example of such an optoelectronic component would be a laser transmitter module for a fibre optic transmission link, in which the laser is rated to operate at a relatively low controlled temperature of 30° C. regardless of the external temperature of the module, which then may vary over a specified range of 0° C. to 85° C. If the thermoelectric cooler cannot be mounted directly to the device, an internal heat sink in close proximity with the device may be provided to convey heat from the device to the thermoelectric cooler.

If the cooling is entirely passive, then an internal heat sink in close proximity with the device may be needed to convey heat from the device to an external surface of the device, which may then be provided with cooling fins.

A problem arises in that for some types of optoelectronic component there are de facto industry standards on the total maximum allowable electrical power consumption. In particular, the Small Form-Factor Pluggable (SFP) Transceiver Multisource Agreement (MSA), which includes transceivers with transmission rates up to 5 Gbit/sec, operating over single mode and multimode fibre, specifies a maximum electrical power consumption of 1 W. Several other MSA's e.g. XFP, SFF, Gbic, Xenpak, Xpak, and X2, specify varying levels of electrical power consumption. Such standards are necessary to maintain interchangeability between similar components manufactured by different sources. There are also industry standards on the package size and configuration of such components, necessary to ensure that similar components from different manufacturers are plug compatible. Such physical constraints limit the amount of passive cooling that may be afforded by heat sinks or cooling fins. Maximum rated temperatures may therefore be considerably less than 85° C.

Because the power consumption of a thermoelectric cooler increases non-linearly, depending on the temperature difference across which heat is pumped, the maximum rated external temperature for an optoelectronic having a maximum rated electrical power consumption depends mainly on the rated operating temperature the optoelectronic device within the component. In recent years, there has therefore been a trend to using optoelectronic devices such as laser diodes which are designed to operate at higher temperatures. This has permitted the maximum rated operating temperature of some optoelectronic components to be increased, for example, to between 0° C. and 70° C.

In recent years there has also been a move towards dense WDM systems, which may have 40 wavelength channels or more. Such systems require better than ±20 pm wavelength control on each channel, and this places increased burdens on the precision of the required temperature control within an optoelectronic component. This in turn tends to limit the maximum operating temperature of an optoelectronic component, which must operate within a constrained electrical power and/or physical size.

There has also been a trend in recent years to higher data rates, for example 10 Gbits/s, and this has resulted in higher electrical power being dissipated within devices. Increased power consumption has also resulted from the use of integrated circuits packaged within a device having more features, resulting in higher drawn current and sometimes higher voltages as compared with older or slower optical transceiver devices. In addition to this, there has been a trend to change the packaging style from co-planar to co-axial packing in order to save packaging cost, but this style of packaging makes it more difficult to dissipate heat generated within the package.

It is an object of the present invention to provide an optoelectronic component with thermoelectric temperature control, which deals with these issues.

### SUMMARY OF THE INVENTION

According to the invention, there is provided optoelectronic assembly, comprising an optical transceiver unit, a heat sink and a housing, in which:
the optical transceiver unit is housed within the housing;
the optical transceiver unit has an interior containing at least one optoelectronic device with at least one electrical connection to said device for providing electrical power to said device, the electrical connection being made through an electrical contact on an external surface of the optical transceiver unit;
the heat sink is mounted to the optical transceiver unit and is in thermal contact with both the optical transceiver unit and the housing to convey waste heat from within the optical transceiver unit to the housing;
the heat sink has at least one conductive electrical path, said path extending between said electrical contact on the external surface of the transceiver to a connection terminal by which electrical power may be supplied to said optoelectronic device.

The term “optical transceiver unit” as used herein refers to any of: an optical receiver unit; an optical transmitter unit; or a combined optical transmitter and receiver unit.

The invention provides a number of benefits. First, heat sink serves two main functions, namely helping to dissipate excess heat, and second to pass through or around the external surfaces of the heat sink electrical connections by which the optical transceiver unit may be connected electrically to electronic circuits external to the optical transceiver unit used in the reception or the transmission of a signal.

In this way the heat sink can readily be made to fill the space near the electrical contacts so that the maximum surface area of the heat sink can be put in thermal contact with the optical transceiver unit and/or the surrounding housing yet still facilitate the electrical connections to be made to the optical transceiver unit.

The heat sink may be mounted to the optical transceiver unit only at said external surface.

The heat sink may be made from any material having good thermal conductivity, for example a metal or a ceramic material. If the heat sink is make of a conductive material, then it will be necessary to provide insulation as part of the electrical path through the body or over the surface of the heat sink.

The optical transceiver unit may have a header plate, in which case the header plate may provide the exposed surface on which the electrical contact is provided.

The term “thermal contact” includes both direct physical contacts between the heat sink on the one hand and the optical transceiver unit or the housing on the other hand, as well as indirect contacts, for example with intervening layers or adhesive compounds, as long as the thermal contacts are close enough so that the heat sink may serve in use to help dissipate waste heat from the optical transceiver unit to the housing.

The invention may comprise a circuit substrate, the optoelectronic device being mounted on one side of the circuit substrate. The electrical connection can then be made on an opposite side of the circuit substrate.

If there are a plurality of electrical contacts, then there is preferably a matching array of electrical paths, each one of which is joined to a corresponding one of the contacts when the heat sink is mounted to the optical transceiver device.

The heat sink may be securely joined to the optical transceiver unit in a variety of ways, for example, by soldering one or more

The circuit substrate may be formed from one or more layers of material, for particularly from ceramic or metal layers.

The circuit substrate may be provided by a so-called “CD header” structure.

The circuit substrate may be a ceramic substrate, in which case the or each electrical connection may extend directly through the substrate, or alternatively may wrap around sides of the substrate for example being plated onto the substrate. If the substrate includes metal or other conductive layers, then the or each electrical connection may be isolated from the conductive layer by a surrounding insulator.

The heat sink terminal may be any of a contact pad, a projecting plug or a recessed socket, adapted to make electrical contact with a matching electrical connection, cable or wire.

In an embodiment of the invention, the electrical connection between the electrical contact of the optical transceiver unit and the electrical path of the heat sink is made at an interface formed by the mounting of the heat sink to the optical transceiver device.

The invention may comprise a circuit substrate having one side that that is internal to the optical transceiver unit and an opposite side that that is external to the optical transceiver unit. The heat sink may then be mounted directly to the opposite side of the circuit substrate.

The heat sink may be mounted only to the circuit substrate in order to maximum the ability of the heat sink to convey waste heat from the optical transceiver unit to the housing.

The heat sink when mounted to the optical transceiver unit may conceal the electrical connection between the electrical contact of the optical transceiver unit and the electrical path of the heat sink. This will protect the concealed connections both mechanically and from the environment.

To facilitate the making of connections, which may be done after assembly of the optical transceiver unit with a portion of the housing, the connection terminal is preferably separate from points of contact between the heat sink, the optical transceiver unit and the housing, and may also be located on an exposed surface of the heat sink. After making of the connections, the assembly of the housing may be completed, for example by affixing a cover plate over the completed electrical connections.

In one embodiment of the invention, the electrical path extends at least partially along one or more external surfaces of the heat sink. In another embodiment of the invention, the electrical path extends through a body of the heat sink. In yet another embodiment of the invention, the electrical path extends both through the body of the heat sink as well as at least partially along one or more external surfaces. In this way, the electrical connections to the optoelectronic device

The heat sink may be in direct contact with the housing, but may alternatively be in indirect contact with the housing, for example in contact with one or more intervening components having good thermal conductivity and in contact with the housing.

Also according to the invention, there is provided a method of forming an optoelectronic assembly, comprising an optical transceiver unit, a heat sink and a housing, comprising the steps of:
placing at least one optoelectronic device inside the optical transceiver unit;
providing at least one electrical connection from said device to a corresponding electrical contact on an exposed surface of the optical transceiver unit;
providing the heat sink with at least one conductive electrical path;
mounting the heat sink to the optical transceiver unit so that the or each electrical contact is connected electrically to a corresponding electrical path;
placing the optical transceiver unit within the housing so that waste heat generated by the consumption of electrical power within the optical transceiver unit is conveyed from within the optical transceiver unit to the housing through the heat sink; and
making at least one electrical connection to the or each optoelectronic device by means of the electrical path(s) and corresponding electrical contacts.

The method may additionally comprise the steps of:
providing the or each electrical path with a corresponding electrical terminal on an exposed surface of the heat sink; and
making said at least one electrical connection to the or each optoelectronic device by means of a corresponding electrical terminal.

### BRIEF DESCRIPTION OF THE DRAWINGS

The invention will now be further described, by way of example only, and with reference to the accompanying drawings, in which:

FIG. 1 shows a perspective view of a prior art optical transceiver unit having a generally cylindrical body with a square header tile at one end to which electrical connections are made to optoelectronic and electrical components within the unit;

FIG. 2 shows a perspective view of an interior surface of the header tile of FIG. 1, showing an photodetector and associated circuitry;

FIG. 3 shows a perspective view of an optical transceiver unit for use in an optoelectronic assembly according to the invention, having a heading tile with a linear array of electrical contacts;

FIG. 4 is an enlarged view of the header tile of FIG. 3;

FIG. 5 is a perspective view of the optical transceiver unit of FIG. 3 and an integrated heat sink connector for use in an optoelectronic assembly according to the invention, prior to joining the heat sink connector to the header tile;

FIG. 6 is a perspective view of the optical transceiver unit and the integrated heat sink of FIG. 5 after these have been joined together;

FIG. 7 is a view from above of the joined transceiver unit and heat sink with an enlarged view of the interface between the transceiver unit and heat sink;

FIG. 8 is a view from above of part of an optical assembly according to the invention, showing an optical transceiver unit of FIG. 3 held in a lower portion of a housing, and with a circuit board spaced apart from the header tile;

FIG. 9 is a view similar to that of FIG. 8, including also the integrated heat sink connector of FIG. 3 joined to the optical transceiver unit and positioned to make electrical connection to the circuit board;

FIG. 10 is a perspective view of FIG. 9, showing how the alignment between the optical transceiver unit and the integrated heat connector may be adjusted prior to final connection of the heat sink to both the optical transceiver unit and the circuit board;

FIG. 11 is a side view of the completed optical assembly of FIG. 9, after an upper portion of the housing has been joined to the lower portion of the housing and showing how the integrated heat sink connector is in thermal contact with the housing so that waste heat from the optical transceiver unit is conducted to the housing;

FIG. 12 is a perspective view of a first embodiment of an integrated heat sink connector having a linear array of leads that pass through the body of the heat sink;

FIG. 13 shows the leads of FIG. 12 in more detail, particularly how insulation surrounds the leads at the base of connection pins to provide electrical isolation from the body of the heat sink;

FIG. 14 is a perspective view of a second embodiment of an integrated heat sink connector having a scattered array of leads through the body of the heat sink;

FIG. 15 shows the leads of FIG. 14 in more detail, particularly how insulation surrounds the leads at the base of connection pads to provide electrical isolation from the body of the heat sink;

FIGS. 16 to 18 illustrate one way of forming the integrated heat sink connector of FIG. 12;

FIGS. 19 and 20 illustrate a second way of forming an integrated heat sink connector similar to that of FIG. 12;

FIGS. 21 and 22 illustrate a third way of forming an integrated heat sink connector using a flexible printed circuit based strip of electrical conductors;

FIGS. 23 and 24 illustrate a fourth way of forming an integrated heat sink connector using a plated electrical tracks on external surfaces of a ceramic block;

FIGS. 25 and 26 show an integrated heat sink connector having a non-cubic form; and

FIGS. 27 and 28 illustrate one way of adhering the integrated heat sink connector of FIG. 12 to the header tile;

### DETAILED DESCRIPTION

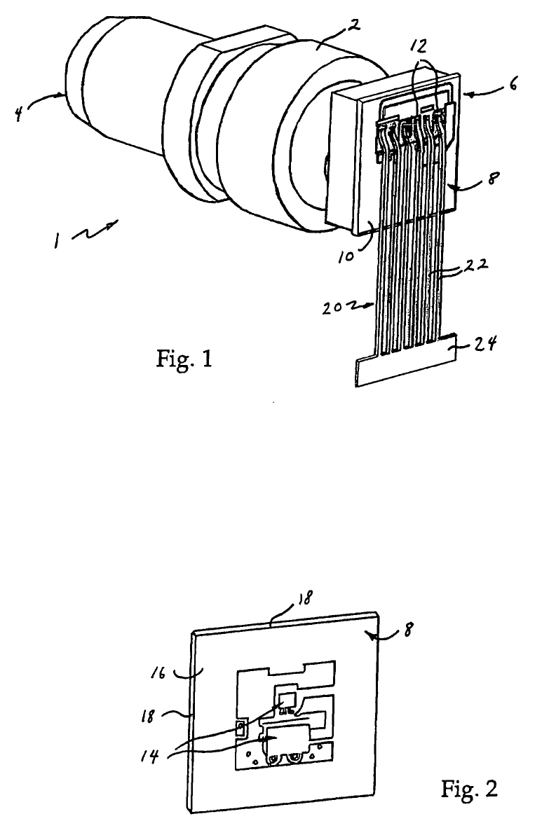

FIG. 1 shows an example of a prior art optical transceiver unit 1 having a generally cylindrical body 2. In this example, the transceiver unit 1 is an optical receiver unit, but this could equally well be an optical transmitter unit. A fibre optic connector (not shown) can be plugged into one end 4 of the unit. At the other end 6, the unit 1 has a square ceramic header tile 8. Such a transceiver unit 1 may be packaged co-axially along with other components within a surrounding housing.

With reference now also to FIG. 2, the header tile 8 is permanently mounted to the body 2 and has a flat external surface 10 on which are positioned electrical contacts 12 by which electrical power (including electrical signals) is provided to optoelectronic and electrical components 14 positioned on a parallel internal surface 16 within the unit 1. The electrical contacts 12 may, as in this example, be connected electrically by vias (not shown) through the header tile, or by means of electrical tracks plated on the surfaces 10,16 and the around edges 18 of the tile 8.

An electrical connector 20 has a number of flexible wires or leads 22 each of which is soldered or brazed at one end to a corresponding electrical contact 12 and at the other end has a connector 24 for connection to a printed circuit board (PCB) (not shown). As can be see from FIG. 1, the arrangement of leads 22 obscures the back of the header tile, which makes it very difficult to connect a heat-sink so that the optoelectronic and electrical components shown in FIG. 2 on the back of the header tile are adequately heat-sunk through the tile. It should also be noted that this arrangement affords little space for electrical connections on or near the header tile 8. Furthermore, because the transceiver unit 1 will be snugly housed within a housing as part of an optoelectronic assembly, there would be little space available for the connections 22. There will normally only be minimal clearance spacing around the edges 18 of the header tile 8, and the electrical connections 22 will therefore have to pass in a narrow gap between the heat sink and the surrounding casing if the heat sink is connected in any way to the exposed surface 10 of the header tile 8.

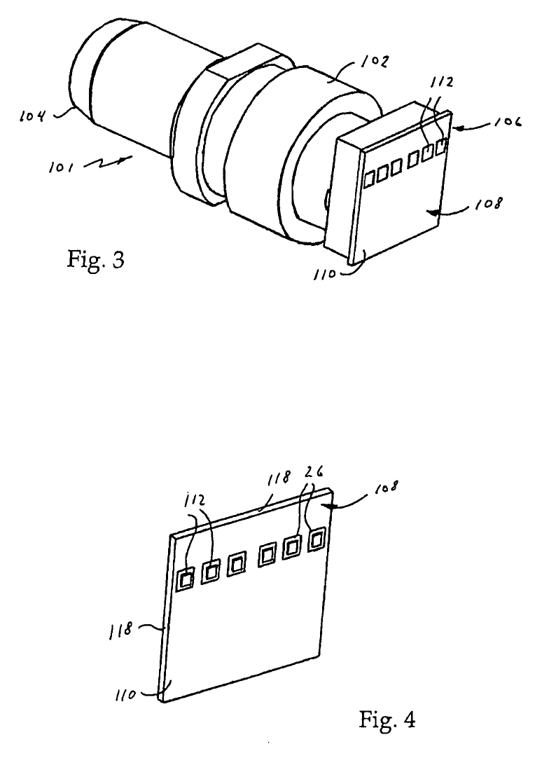

FIG. 3 shows a first embodiment of an optical transceiver unit 101 for use in an optoelectronic assembly according to the invention. In FIG. 3, features that correspond with those of FIG. 1 are indication with reference numerals increments by 100. The transceiver unit 101 differs from the prior art in having a linear array of electric contacts 112 that are raised with respect to the surrounding exposed surface 110 of the ceramic header tile 108. As will be explained below, this is to facilitate electrical connection to an integrated heat sink connector having a matching array of electrical contacts.

As shown in greater detail in FIG. 4, each contact 112 is surrounded by an insulator 26 so that each contact is isolated from the header 108. The contacts 112 may be plated with gold and could have solder pre-deposited on them or be coated with an electrically conducive epoxy.

It should be noted that instead of a ceramic header tile 108, a metal CD header could equivalently be used.

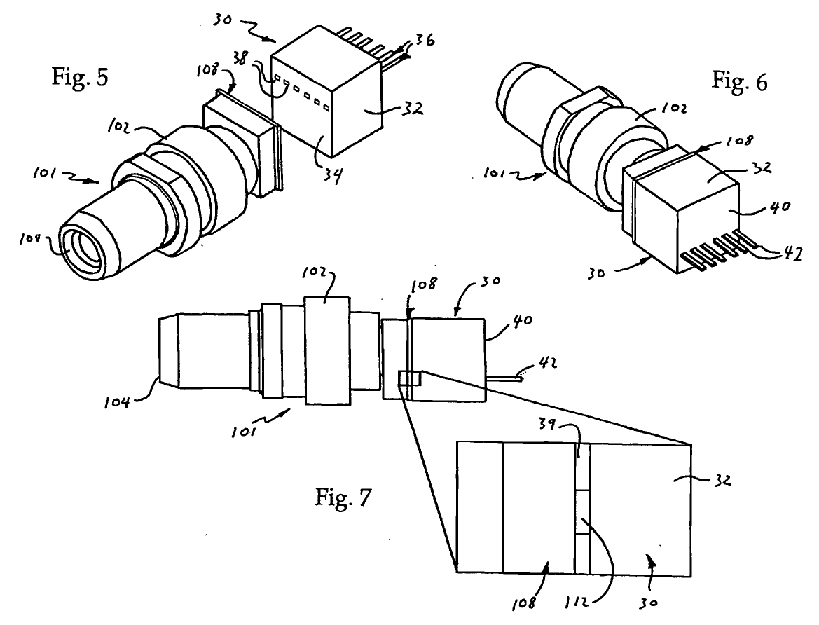

Reference is now made to FIGS. 5, 6 and 7, which show various views of the optical transceiver unit 101 of FIG. 3 and an integrated heat sink connector 30 for use in an optoelectronic assembly according to the invention. The heat sink connector 30 has a generally cubic body 32 a front face of which 34 has the same dimensions as the external surface 110 of the header tile 108.

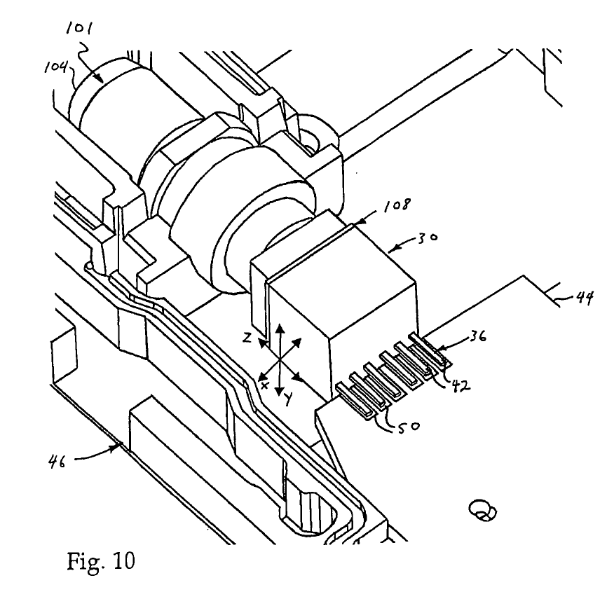

A number of parallel electrical connections 36 run through the header body 34. At the front face each connection 36 terminates in a contact 38 that is flush or slightly raised with respect to the front surface 34. At a rear surface 40 of the header body 32 opposite the front face 34 each connection 36 extends as a lead or terminal 42 for solder connection to a printed circuit board (PCB) 44 as shown in FIG. 9.

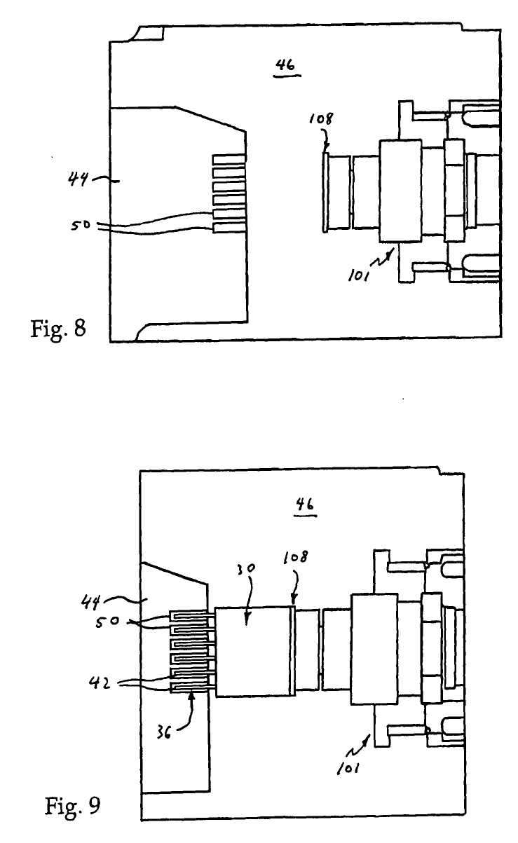

FIGS. 8-10 show how the both the optical transceiver unit 101 and the PCB 44 are first located with respect to a housing lower portion 46. The front surface 34 of the integrated heat sink connector 30 is then brought into contact with the exposed surface 110 of the optical transceiver unit 101 until each of the heat sink contacts 38 registers with a corresponding solder/epoxy covered contact 112 of the transceiver unit, while at the same time bringing each of the heat sink terminals 42 into contact with a matching pad 50 on the PCB 44. The pads 50 and terminals 42 have dimensions that afford an ample latitude of adjustment along the z-axis, while the relative sizes of the heat sink and header tile surfaces 34, 110 allow adjustment along the x-axis and y-axis. The PCB pads 50 may be enlarged at least in the z-axis direction to facilitate the aligning of the heat-sink connector 30.

The contacts 112 and are preferably larger than those 12 in the prior art to accommodate movement in the heat-sink connector block for easy alignment, although it would be possible to keep the contacts 112 the same size as in the prior art and then make the heat sink contacts 38 correspondingly larger.

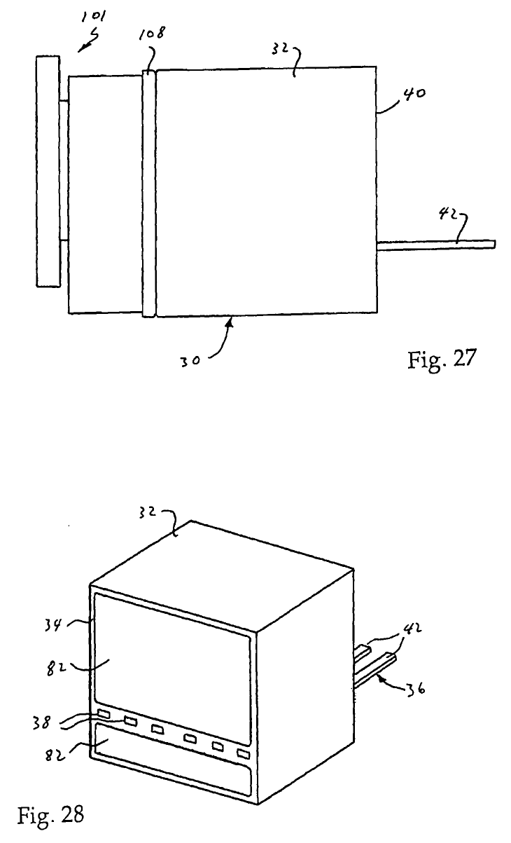

The heat-sink connector 30 therefore takes up any alignment tolerances between the optical transceiver unit 101 and the PCB 44 in the x, y and z-axes. In this way, all the contacts, terminal and pads can be brought into simultaneous contact, after which these are electrically bonded together, for example by soldering or with a conductive epoxy glue. As will be explained below with reference to FIGS. 27 and 28, after making of the electrical connections, the header tile 108 may be bonded to the integrated heat sink connector 30 by means of a thermally conductive epoxy. Once the contacts, terminal and pads are aligned then either the whole heat-sink block would be heated to melt the solder. Alternatively if epoxy is used then the components would be held in a fixture and then cured in an oven to lock the parts together.

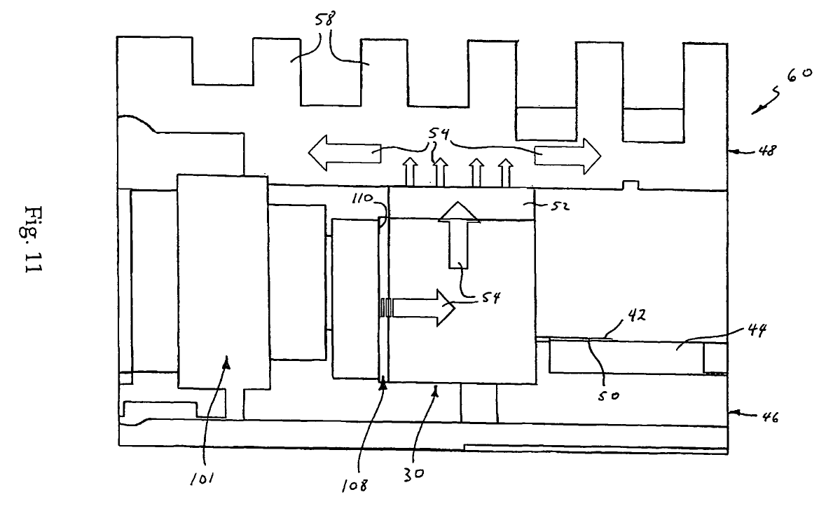

FIG. 11 shows in a schematic cross-section, how a housing upper portion 48 is joined to the housing lower portion 46 to complete the optoelectronic assembly 60. The assembly 60 therefore comprises the optical transceiver unit 101, the integrated heat sink connector 30, the PCB 44, and the housing lower and upper sections 46, 48. As can be seen, the housing upper section 48 is in thermal contact with the housing upper section 48 via an intermediate spacer 52, which can also be bonded by means of a thermally conductive epoxy adhesive to both the heat sink 30 and the upper housing 48. The heat generated within the ceramic header tile 108 from the opto-electronics would pass through the header tile and through the epoxy on the exposed surface 110 of the header tile into the integrated heat sink connector 30. This arrangement therefore forms a heat path 54 for cooling the opto-electronics inside the optical transceiver unit 101 to the transceiver housing 46, 48 via the integrated heat sink connector 30.

Alternatively, instead of a spacer 52, material such as an epoxy or compliant thermally conductive material could be used transfer 54 the heat from the heat sink 30 into the assembly housing 46, 48.

Once the heat has spread to the assembly housing 46, 48, this would be radiated and/or convected away to the outside world, for example with the aid of heat fins 58, thus keeping the optoelectronics inside the optical transceiver unit 101 cool.

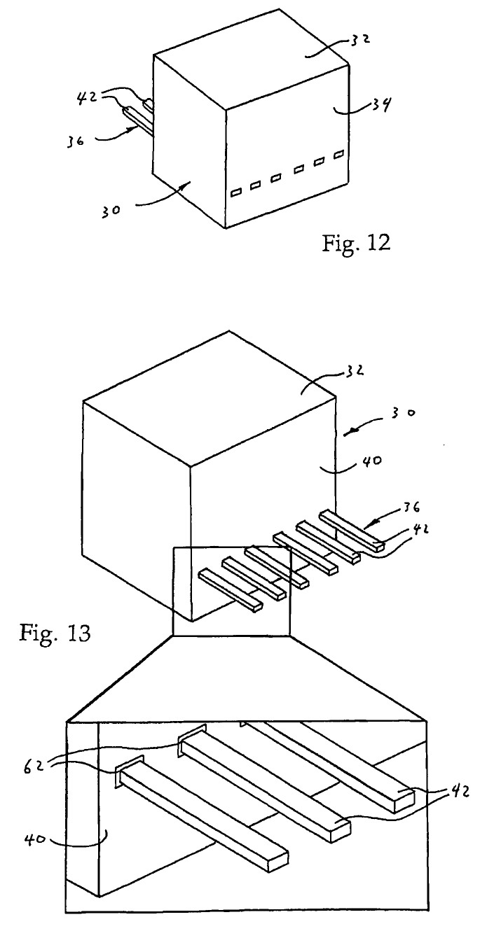

FIGS. 12 and 13 show the integrated heat sink connector 30 in greater detail. The electrical conductors 36 could be etched, or machined, or extruded leads. Note that although these are shown in a rectangular shape, these could have any profile, for example round, triangular etc.

The heat sink body 32 may be made from a high thermal conductivity material such as aluminium, copper or aluminium nitride. The body 32 could also incorporate heat-pipes as well to maximise heat spreading within the body 32.

Non-conductive coating 62 on the conductor leads insulates these from the heat sink body 32. Note that one ground lead could potentially not have this coating 62 so that it is in electrical contact with the heat sink body 32. This would be to help screen the other conductor leads 36 from “noise” and cross-talk. If the heat sink body 32 is not made from an electrically conductive material such as Aluminium Nitride, and is insulating then the insulating coating 62 would not be required.

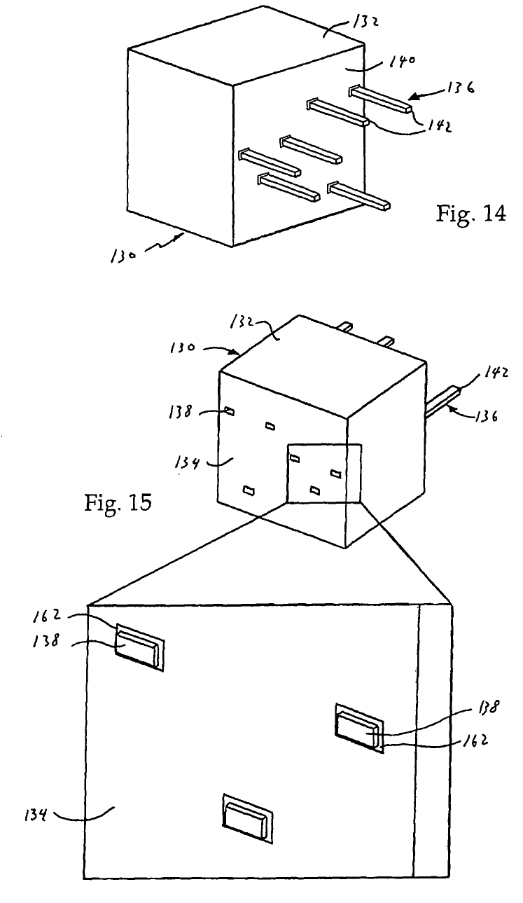

FIGS. 14 and 15 show a second embodiment of an integrated heat sink connector 130, in which features that correspond with those of the heat sink 30 described above are indicated with reference numerals incremented by 100. The integrated heat sink connector 130 differs in that the connector leads 136 are staggered in order to reduce the track length on the header tile 108. As before, a non-conductive coating 162 on the conductor leads 136 insulates these from the heat sink body 132.

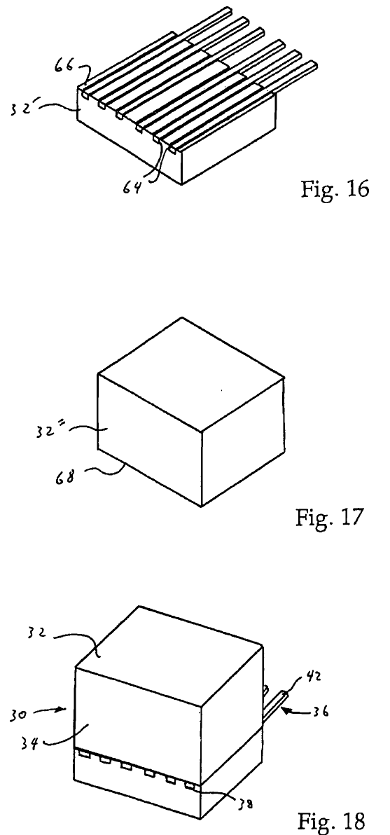

FIGS. 16, 17 and 18 show how the integrated heat sink connector 30 could be manufactured. The heat-sink connector body 32 could be formed in two portions 32′ and 32″. In one portion 32′ a number of parallel channels 64 are machined into a flat surface 66 and into which the connector leads 36 are seated, after application of the insulating coating 62 if necessary. The other portion 32″ of the heat sink body 32 is machined to have a matching flat surface 68 to which a thermally conductive epoxy adhesive is applied prior to bringing the matching surfaces 66,68 together and bonding the portions 32′, 32″ together to form the complete integrated heat sink connector 30.

The portions could, alternatively, be moulded rather than machined.

The skilled person will recognize that there are other manufacturing processes and materials, which could alternatively be used to form the integrated heat sink connector 30.

The insulating coating 62 on the conductor leads 36 could be a plastic coating of the “heat shrink” type, or the conductor leads 62 could be plastic dipped and have the uncoated ends trimmed off.

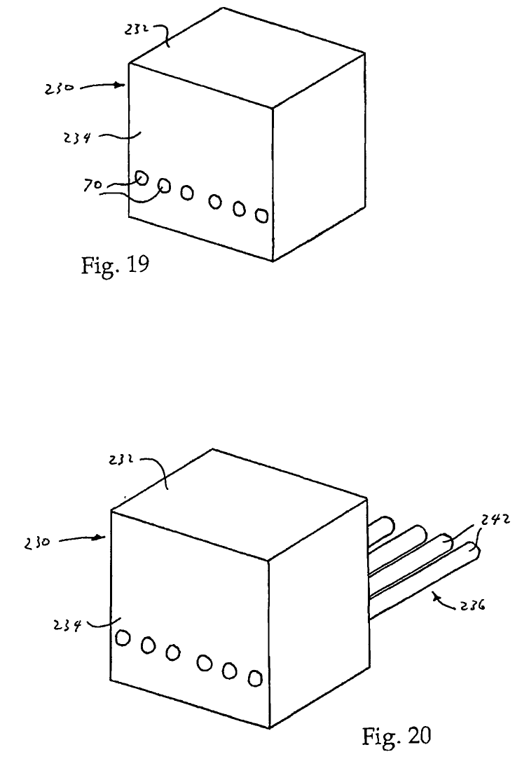

FIGS. 19 and 20 show a third embodiment of an integrated heat sink connector 230, in which features that correspond with those of the heat sink 30 described above are indicated with reference numerals incremented by 200. The integrated heat sink connector 230 differs in that a number of holes 70 are first drilled in the heat sink body 232. Alternatively, the body 232 could be moulded with these holes 70.

Connector leads 236 having a matching circular cross-section could be push fit into the holes 70 in heat sink body 232, if the body is electrically non-conductive. If the heat sink body 232 is conductive, then the connector leads 236 could be coated with a suitable insulator (not shown).

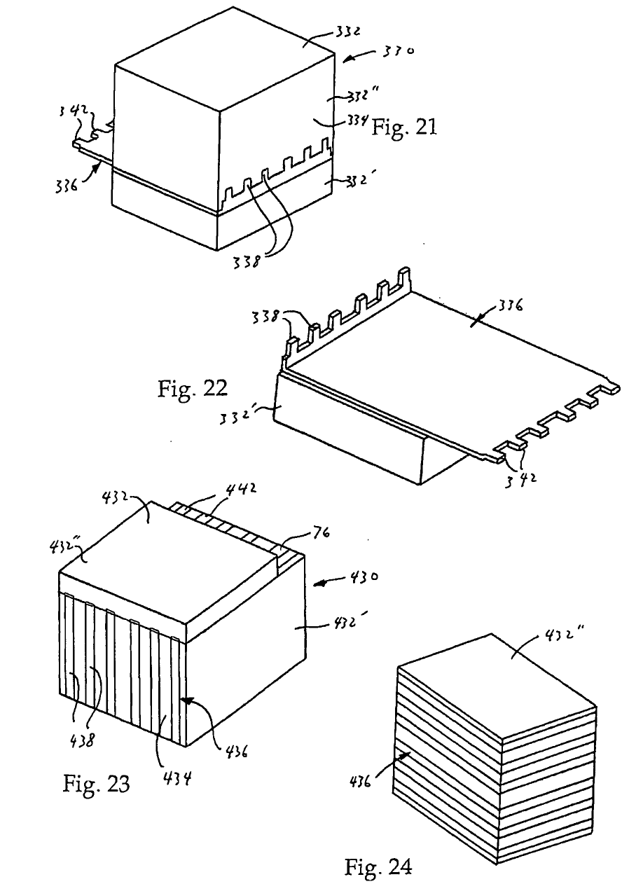

FIGS. 21 and 22 show a fourth embodiment of an integrated heat sink connector 330, in which features that correspond with those of the second embodiment of the integrated heat sink connector 130 described above are indicated with reference numerals incremented by 200. The integrated heat sink connector 330 differs in that a PCB flex cable 336 is bonded between two portions 332′, 332″ that together form the heat sink body 332.

The flex cable 336 would have tracks (not shown) running from one tab 338 to the other 342, all of which would be encased in a non-conductive coating so that this would not short out on the heat sink body 332. Exposed metal tabs on the ends of the flex 336 would make electrical contact with both the optical transceiver unit 101 and PCB 44.

FIGS. 23 and 24 show a fifth embodiment of an integrated heat sink connector 430, in which features that correspond with those of the second embodiment of the integrated heat sink connector 130 described above are indicated with reference numerals incremented by 300. The integrated heat sink connector 430 differs in that thick gold tracks 436 are printed onto a one portion 432″ of two ceramic portions 432′, 432″ to form the electrical connections across the heat sink body 432. The arrangement is such that a ledge 76 is formed by an offset in the dimensions of the portions 432′ and 432″ which can then be soldered directly to the PCB pads 50. On the face 434 of the heat sink for connection to the contacts 112 of the optical transceiver unit 101, the tracks 236 run parallel across the face in the y-axis direction. This side 434 of the ceramic heat sink body 432 would connect to the ceramic header tile 108 making both a thermal contact and the electrical contacts.

In an alternatively embodiment not shown in the drawings, the gold tracking could be “wrapped around” a single ceramic block to connect to both the optical transceiver unit 101 and the PCB 44.

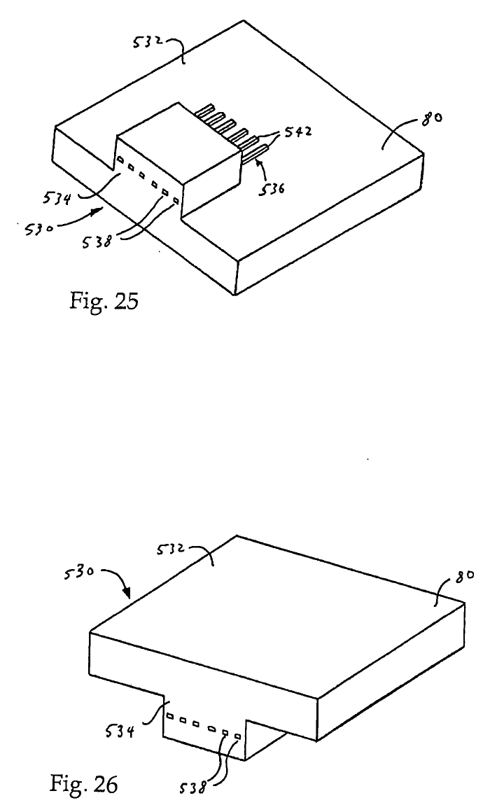

FIGS. 25 and 26 show a fifth embodiment of an integrated heat sink connector 530, in which features that correspond with those of the first embodiment of the integrated heat sink connector 30 described above are indicated with reference numerals incremented by 500. The integrated heat sink connector 530 has a plate 80 that is parallel with the direction of the electrical connections 536 but offset transversely from the PCB terminals 542. The plate 80 has a large surface area for making a greater thermal contact with the housing 46, 48. Additional heat carrying capacity may also be provided by heat-pipes (not shown) inside the heat sink body 532.

The heat-sink connector block can be made into any convenient shape, providing that this fits into the optical transceiver housing. The advantages in making the heat sink bigger as in FIGS. 25 and 26 is that this would increase the amount of surface area in contact the module housing and also it would provide more thermal mass to heat up. Both of these would result in the opto-electronics being cooler.

FIGS. 27 and 28 show how the integrated heat-sink connector 30 could be connected to the header tile 108 of the optical transceiver unit 101 using a thermally conductive epoxy 82. An epoxy pre-form 82 could be added to the heat sink connector front face 34 prior to the electrical contacts 38 being epoxied or soldered onto the contacts 112 on the exposed surface 110 of the header tile 108. This pre-form 82 could then be cured once the leads have been attached (or at the same time).

Alternatively, once the electrical contacts 38 are epoxied or soldered onto the exposed surface 110 of the header tile 108, then a thermally conductive epoxy 82 would be injected in the gap between the heat sink body 32 and the header tile 108 to provide a strong joint and also a good thermal path 54 for waste heat.

The invention therefore provides a convenient solution to the problem of dissipating waste heat from an optical transceiver unit, particularly when such a unit is housed in a co-axial package. The integrated heat sink connector permits the optoelectronic components inside an optoelectronic assembly to be kept at an acceptable temperature, while at the same time allowing the optical transceiver unit to be connected axially to a other components, for example a printed circuit board (PCB). It also allows for simpler processes techniques to be adopted for building the transceiver unit and may simplify the connection to a PCB whiles maintaining the correction alignment of the transceiver unit within the overall assembly. In addition to this, one of the variants described above with reference to FIG. 10 allows the leads to be aligned very closely to the opto-electronics pads resulting in shorter tracks to be used on the optical transceiver unit giving potential to further improve the radio frequency (RF) characteristics of the devices.

The invention addresses the problem that leads need to be connected electrically to the back of a ceramic tile/metal CD header and therefore effectively get in the way of any heat sink cooling solution. Contact leads have traditionally always been brazed or soldered to the back of the ceramic tile/CD header which in turn means there is little area left on the header to make contact with a heat-sink. The invention does not require that the leads should be offset to one side of the header so that leads extend to the top or bottom of the tile/CD header. A problem with this approach would be that it is then very awkward to route the leads in the confined space around the heat sink and onto the PCB, which can also make the leads very long, thus reducing the quality of the eye pattern of received or transmitted data. Long exposed leads can also result in these acting like aerials which pick up and receive/transmit unwanted noise from/to surrounding components, leading to the problem of “cross-talk” whereby the sensitivity of an optical receiver unit is decreased and the jitter or noise of an optical transmitter unit is made worse.

This invention provides significant benefits by integrating the leads and heat sink material into one block, resulting in cooler optoelectronic and electronic devices within the optical transceiver unit, and also by reducing the length of leads making a connection to connection pads on the header. The advantages in doing this are numerous. Cooler optoelectronic components significantly increase the reliability of the optoelectronic assembly. Lower operating temperatures also provide a marked improvement in performance of the optical transceiver unit, and increased available bandwidth. The invention may also permit the transceiver to operate at higher case or ambient temperatures, which is highly desirable as it allows a higher density of optical transceiver units. It also eases the assembly of the optical transceiver unit by easing the alignment between the transceiver body and a printer circuit board (PCB), as now the leads are free to move until the integrated heat sink connector is soldered or otherwise bonded to the transceiver unit. This helps because normally the leads are fixed to the header before being attaching to the PCB and since the optical transceiver unit port position is always fixed (as are the PCB pads) this makes it hard to align both with respect to each other. With the leads free to move they can be accurately aligned and then fixed in place to both the PCB and the optical transceiver unit, thus making the optoelectronic assembly easier to manufacture. By encasing the leads in a conductive heat-sink it is also possible for some variants of this invention to reduce the “cross talk” between the optical transceiver unit and surrounding integrated circuits or other components, because the leads are effectively shielded by the heat sink which can readily be connected to ground.

1. An optoelectronic assembly, comprising an optical transceiver unit, a heat sink and a housing, in which:
the optical transceiver unit is housed within the housing;
the optical transceiver unit has an interior containing at least one optoelectronic device with at least one electrical connection to said device for providing electrical power to said device with at least one electrical connection to said device for providing electrical power to said device, the electrical connection being made through an electrical contact on an external surface of the optical transceiver unit;
the heat sink is mounted to the optical transceiver unit and is in thermal contact with both the optical transceiver unit and the housing to convey waste heat from within the optical transceiver unit to the housing;
the heat sink has at least one conductive electrical path, said path extending between said electrical contact on the external surface of the transceiver to a connection terminal by which electrical power may be supplied to said optoelectronic device.

2. An optoelectronic assembly as claimed in claim 1, comprising a circuit substrate, the optoelectronic device being mounted on one side of the circuit substrate, said electrical connection being made on an opposite side of said circuit substrate.

3. An optoelectronic assembly as claimed in claim 1, in which the electrical connection between the electrical contact of the optical transceiver unit and the electrical path of the heat sink is made at an interface formed by the mounting of the heat sink to the optical transceiver unit.

4. An optoelectronic assembly as claimed in claim 1, comprising a circuit substrate, said substrate having one side that is internal to the optical transceiver unit and an opposite side that that is external to the optical transceiver unit, the heat sink being mounted directly to said opposite side of said circuit substrates.

5. An optoelectronic assembly as claimed in claim 1, in which the heat sink when mounted to the optical transceiver unit conceals the electrical connection between the electrical contact of the optical transceiver unit and the electrical path of the heat sink.

6. An optoelectronic assembly as claimed in claim 1, in which the connection terminal is separate from points of contact between the heat sink, the optical transceiver unit and the housing.

7. An optoelectronic assembly as claimed in claim 1, in which the connection terminal is on an exposed surface of the heat sink.

8. An optoelectronic assembly as claimed in claim 1, in which the electrical path extends at least partially along one or more external surfaces of the heat sink.

9. An optoelectronic assembly as claimed in claim 8, in which the electrical path extends through a body of the heat sink.

10. An optoelectronic assembly as claimed in claim 1, in which the heat sink is in direct contact with the housing.

11. A method of forming an optoelectronic assembly, comprising an optical transceiver unit, a heat sink and a housing, comprising the steps of:
placing at least one optoelectronic device inside the optical transceiver unit;
providing at least one electrical connection from said device to a corresponding electrical contact on an exposed surface of the optical transceiver unit;
providing the heat sink with at least one conductive electrical path;
mounting the heat sink to the optical transceiver unit so that the or each electrical contact is connected electrically to a corresponding electrical path;
placing the optical transceiver unit within the housing so that waste heat generated by consumption of electrical power within the optical transceiver unit is conveyed from within the optical transceiver unit to the housing through the heat sink; and
making at least one electrical connection to the or each optoelectronic device by means of the electrical path(s) and corresponding electrical contacts.

12. A method as claimed in claim 1, comprising:
providing the or each electrical path with a corresponding electrical terminal on an exposed surface of the heat sink; and
making said at least one electrical connection to the or each optoelectronic device by means of a corresponding electrical terminal.
